(19) United States
(12) Patent Application Publication
(10) Pub. No.: US 2007/0223890 A1
(43) Pub. Date: Sep. 27, 2007

(54) Optical disc apparatus

(75) Inventor: Mitsuharu Osaki, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/715,990

(22) Filed: Mar. 9, 2007

(30) Foreign Application Priority Data
Mar. 24, 2006 (JP) 2006-083260

(51) Int. Cl. H04N 5/00

(52) U.S. Cl. 386/126

(57) ABSTRACT

Provided is an optical disc apparatus capable of achieving a time search even if a loaded optical disc is a DVD on which information is recorded in +VR format. A system controller equipped in the optical disc apparatus adds up playback times of cells sequentially from a first cell and finds a cell that includes a search time as a target cell when time search processing based on the search time that is inputted is performed on a +VR formatted DVD; obtains a position of a first VOBU of the target cell in a VOBU address map; calculates a playback time per VOBU; calculates a position of a target VOBU in the VOBU address map; and obtains a finally targeted VOBU in the time search by using search information of the target VOBU when a difference between the search time and a sum of a playback time leading to the target VOBU and an elapsed time of the target VOBU within cell is determined within, for example, ±3 seconds.

This application is based on Japanese Patent Application No. 2006-083260 filed on Mar. 4, 2006, the contents of which are hereby incorporated by reference.

### BACKGROUND OF THE INVENTION

1. Field of the Invention

The present invention relates to an optical disc apparatus that reproduces data recorded on an optical disc or that records/reproduces data on an optical disc. More particularly, the present invention relates to time search processing for a DVD+VR (Digital Versatile Disc+Video Recording) formatted disc.

2. Description of Related Art

As apparatuses that reproduce information recorded on an optical disc, such as a DVD (Digital Versatile Disc), CD (Compact Disc), or the like, optical disc apparatuses, such as DVD players or DVD recorders, have been widespread. To quickly find desired information from a DVD for reproduction, title search, chapter search, and time search are used. To quickly find desired information from a CD for reproduction, track search and time search are used.

For example, in reproduction from a DVD, the title search, chapter search, or time search will be performed through the following procedure. First, a DVD from which reproduction is to be performed is first loaded into the optical disc apparatus. Then, a menu key on a remote controller is pressed so as to display a menu screen on a display apparatus. From among menu items on the menu screen, “title search”, “chapter search”, or “time search” is selected by pressing a Direction key on the remote controller and then determined by pressing a Determine key thereon, whereby the optical disc apparatus is set in any one of the modes, title search, chapter search, and time search.

In reproduction from a CD, the track search or time search will be performed through the following procedure. First, a CD from which reproduction is to be performed is first loaded into the optical disc apparatus. Then, the menu key on the remote controller is pressed so as to display a menu screen on a display apparatus. From among menu items on the menu screen, “track search” or “time search” is selected by pressing the Direction key on the remote controller and then determined by pressing the Determine key thereon, whereby the optical disc apparatus is set in either of the modes, track search or time search.

The +VR format is provided as a format for recording information on a DVD. However, although the +VR format is compatible with the DVD Video format, its control data is simplified to reduce a burden on the side of the apparatus. For this reason, in the +VR format, there is provided no time map table necessary for the time search and, consequently, this makes it impossible to perform the time search under present circumstances.

JP-A-2005-276439 discloses an information recording medium that enables a quick time search of recorded information regardless of the recording methods, such as a variable bit rate compression, a constant bit rate compression, and a non-compression, by using an information reproducing apparatus that has relatively a simple structure. However, this document fails to disclose a time search for a DVD on which information is recorded in +VR format.

### SUMMARY OF THE INVENTION

An object of the present invention is to provide an optical disc apparatus capable of achieving a time search even if a loaded optical disc is a DVD on which information is recorded in +VR format.

According to one embodiment of the present invention, an optical apparatus reproduces data recorded on an optical disc or records/reproduces data on an optical disc, and is provided with a system controller that, when a loaded optical disc is a +VR formatted DVD and a time search based on an inputted search time is performed on this DVD, sums up, sequentially from a first cell, playback times of a plurality of cells that constitute a VOBU on the +VR formatted DVD and searches a cell that includes the search time as a target cell. Then, the system controller obtains a position of a first VOBU of the target cell in a VOBU address map that indicates a relationship between a VOBU number and an address thereof based on the VOBU number of the first VOBU, and calculates a playback time per VOBU from a difference between elapsed times within cell of the first VOBU and a next VOBU. The system controller also calculates a position of a target VOBU in the VOBU address map based on the position of the first VOBU in the VOBU address map, the search time, a playback time leading to the first VOBU, and the playback time per VOBU, and obtains a finally targeted VOBU in the time search by using search information of the target VOBU when a difference between the search time and a sum of a playback time leading to the target VOBU and an elapsed time of the target VOBU within cell is within a predetermined duration.

With this configuration, it becomes possible to achieve a time search on a +VR formatted disc, which has been difficult conventionally, by using such control information as the playback time of cell, the VOBU address map, the elapsed time of VOBU within cell, and the search information of VOBU, thereby enhancing the user friendliness.

### BRIEF DESCRIPTION OF THE DRAWINGS

FIG. 1 is a block diagram showing the structure of an optical disc recording/reproducing apparatus as an optical apparatus according to one embodiment of the present invention;

FIG. 2 is a schematic diagram showing a structure of a title recorded on a DVD in +VR format according to one embodiment of the present invention;

FIG. 3 is a schematic diagram for explaining one example of contents of a VOBU address map that is used for time search processing according to one embodiment of the present invention; and

FIG. 4 is a flowchart for explaining the time search processing according to one embodiment of the present invention.

### DETAILED DESCRIPTION OF PREFERRED EMBODIMENTS

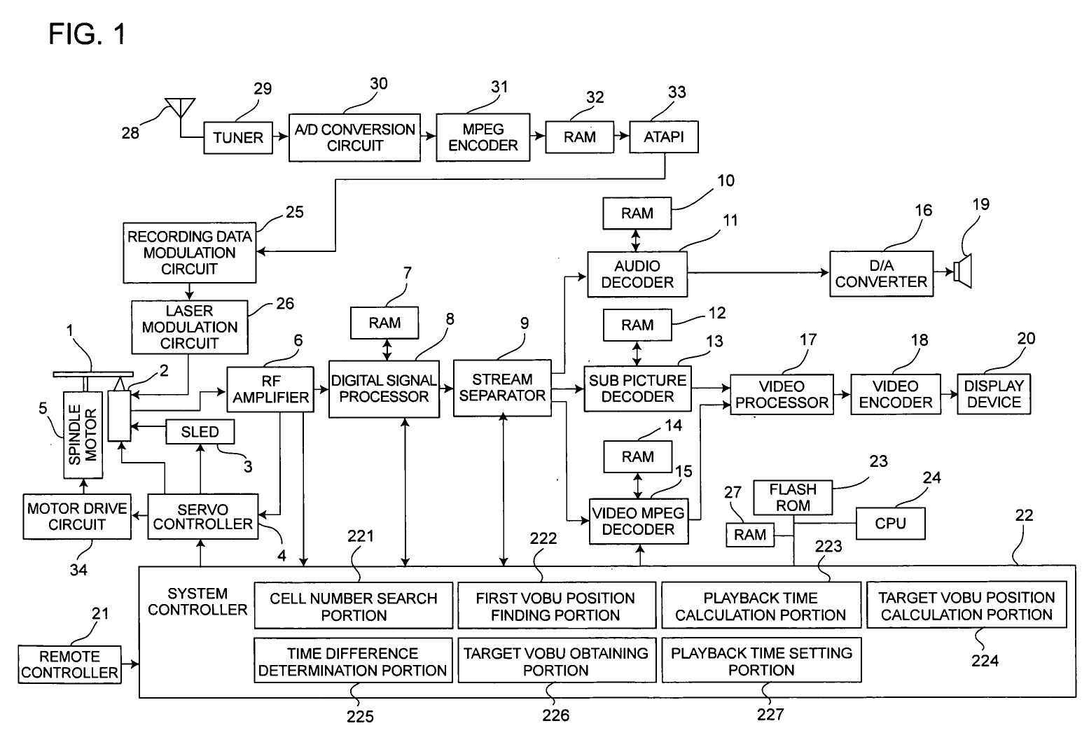

Hereinafter, an embodiment of the present invention will be described with reference to the accompanying drawings. FIG. 1 is a block diagram showing the structure of an optical disc recording/reproducing apparatus as an optical apparatus according to one embodiment of the present invention. Although an optical disc apparatus dealt with in this embodiment is an optical disc recording/reproducing apparatus such as a DVD recorder, the optical disc apparatus of the invention may be an optical disc reproducing apparatus such as a DVD player.

This optical disc apparatus is provided with: a system controller 22 that controls an entire apparatus; a spindle motor 5 which rotates an optical disc 1; an optical pickup 2 that optically writes and reads information to and from the optical disc 1; a sled 3 for moving this optical pickup 2 in the radial direction of the optical disc 1; and servo controller 4 which, in accordance with instructions from a system controller 22, drives the spindle motor 5 and the sled 3 via a motor drive circuit 34 and operates an objective lens (not shown) built in the optical pickup 2 to thereby perform control of moving the focal position of a laser beam perpendicularly and horizontally with respect to the recording surface of the optical disc 1.

The optical disc recording/reproducing apparatus is also provided with: an RF amplifier 6 that amplifies an RF signal which is the read signal from the optical pickup 2 when data from the optical disc 1 is reproduced; a digital signal processor 8 that converts the RF signal outputted from the RF amplifier 6 into digital data, then performs signal demodulation and error correction according to the data format of the optical disc 1, and then stores the resultant data in a RAM 7 serving as a buffer memory; and a stream separator 9 that separates audio data, subpicture data, and video data from the data stream outputted from the digital signal processor 8 according to instructions from the system controller 22.

Furthermore, the optical disc recording/reproducing apparatus is also provided with: an audio decoder 11 that receives audio data outputted from the stream separator 9 and then performs predetermined decoding processing; a RAM 10 that temporarily stores data for performing the decoding processing in the audio decoder 11; a subpicture decoder 13 that receives subpicture data outputted from the stream separator 9 and then performs predetermined decoding processing; a RAM 12 that temporarily stores data for performing the decoding processing in the subpicture decoder 13; a video MPEG decoder 15 that receives video data outputted from the stream separator 9 and then performs decoding processing according to the MPEG standard; and a RAM 14 that temporarily stores data for performing the decoding processing in the video MPEG decoder 15.

The optical disc recording/reproducing apparatus is also provided with: a video processor 17 that synthesizes data outputted from the video MPEG decoder 15 and data outputted from the subpicture decoder 13 according to instructions from the system controller 22; a video encoder 18 that converts the synthesized data outputted from the video processor 17 into a video signal for display and makes a display device 20 display images thereof; and a D/A converter 16 that converts data outputted from the audio decoder 11 into an analog audio signal, and then feeds the audio signal to, for example, a loudspeaker 19 through an unillustrated audio circuit.

The optical disc recording/reproducing apparatus is also provided with: a remote controller 21 having various operation keys such as a recording key for giving a recording instruction to the system controller 22, a playback key for giving a playback instruction thereto, and a stop key for giving a recording/playback stop instruction thereto; and an apparatus main operation portion (not shown) provided with fewer operation keys than those of the remote controller 21. Furthermore, the optical disc recording/reproducing apparatus is also provided with: a flash ROM 23, which is a nonvolatile memory, that stores a program or data for controlling the entire apparatus; a CPU 24 that performs arithmetic operations according to the program or data stored in the flash ROM 23 and controls the system controller 22; and a RAM 27 that temporarily stores data required for the arithmetic operations performed by the CPU 24.

The optical disc recording/reproducing apparatus is also provided with: a tuner 29 connected to an antenna 28; an A/D conversion circuit 30 that converts analog video/audio signals of a television broadcast selected by the tuner 29 or video/audio signals outputted from a television receiver or another audio/visual output apparatus (not shown) into digital video/audio data; an MPEG encoder 31 that encodes the video/audio data according to the MPEG standard; a RAM 32 that serves as a buffer memory for temporarily storing a predetermined amount of the encoded video/audio data (hereinafter “encoded data”); an ATAPI (AT Attachment Packet Interface) 33 that serves as an interface between the RAM 32 and a recording data modulation circuit 25; the recording data modulation circuit 25 that modulates the encoded data transmitted from the ATAPI 33 for recording on the optical disc 1; and a laser modulation circuit 26 that outputs to the optical pickup 2 a laser modulation signal for modulating laser light based on the modulated data resulted from the modulation in the recording data modulation circuit 25.

The system controller 22 that performs time search processing on a loaded +VR (Video Recording) formatted DVD has the following constituting elements. A cell number search portion 221 sums up a playback time of each cell sequentially from the beginning of a plurality of cells that constitute a VOBS (Video Object Set) on the +VR formatted disc and searches for a cell number of a target cell with which the summed duration includes a search time that is operationally set. A first VOBU position finding portion 222 finds which position a first VOBU (Video Object Unit) is located in a VOBU address map that indicates a corresponding relationship between a VOBU number and an address thereof based on a position of a first VOBU. A playback time calculation portion 223 calculates a playback time per VOBU from a difference between elapsed times within cell of the first VOBU and the next VOBU. A target VOBU position calculation portion 224 calculates a position of a target VOBU in the VOBU address map based on the position of the first VOBU in the address map, the search time that is operationally set, a playback time leading to the first VOBU, and the playback time per VOBU.

The system controller 22 also has the following constituting elements. A time difference determination portion 225 determines whether or not a time difference between the operationally set search time and the sum of a playback time leading to the target cell and the elapsed time within cell of the target VOBU is within a predetermined time. A target VOBU obtaining portion 226, when it is determined that the difference between the operationally set search time and the sum of the playback time leading to the target cell and the elapsed time within cell of the target VOBU is within the predetermined time, obtains a finally targeted VOBU in the time search by using search information of VOBU. A playback time setting portion 227, when it is determined the difference between the operationally set search time and the sum of the playback time leading to the target cell and the elapsed time within cell of the target VOBU is not within the predetermined time, in order to correct the playback time per VOBU which is calculated by the playback time calculation portion 223, sets a predetermined duration to the playback time per VOBU.

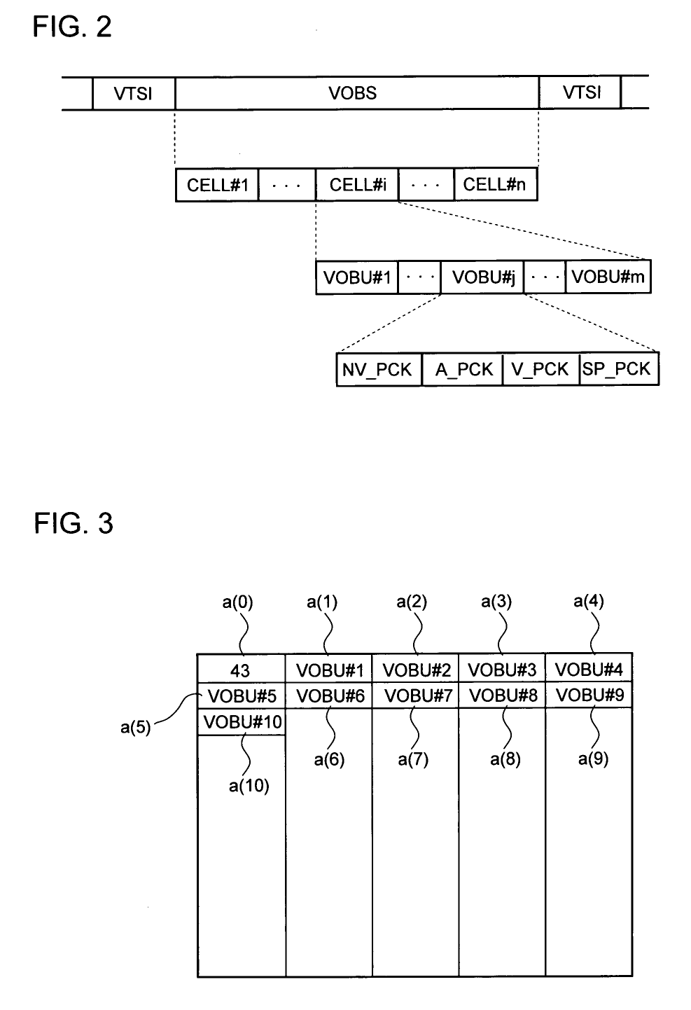

FIG. 2 is a schematic diagram showing a structure of a title recorded on a DVD in +VR format according to one embodiment of the present invention. This DVD has a lead-in area (not shown) in the most inner drive area and, at the same time, a lead-out area (not shown) in the most outer drive area. Recorded therebetween are video data and audio data that are divided into a plurality of video title sets (VTS) each having an identification number. Here, the video title set (VTS) represents a set of related video titles bundled together. A video object set (VOBS) is arranged between one video title set information (VTSI) and another video title set information (VTSI) which represents the information relating to the video title set (VTS). Hereinafter, to separate control information that is other information constituting the video title set (VTS) from a plurality of video title sets (VTS) that represent a substantial portion of the video and audio data, the substantial portion is called a video object set (VOBS).

The video object set (VOBS) is comprised of a plurality of cells (CELL #1-CELL #n). Each of the cells is comprised of a plurality of video object units (VOBU). For example, CELL #1 is made up of a video object unit (VOBU #1), . . . a video object unit (VOBU #j), . . . a video object unit (VOBU #m). Each video object unit (VOBU) includes a navigation pack (NV_PCK), an audio pack (A_PCK), a video pack (V_PCK), and a subpicture pack (SP_PCK).

As control information included in a DVD and used for achieving a time search on the +VR formatted DVD, there are control information concerning playback times of cells, control information concerning a VOBU address map, control information concerning elapsed times of VOBUs within cell, and search information of VOBU.

Therefore, the playback time of a cell can be obtained by sequentially tracing through such control information as the control data of video title set information (VTSI), a video title set program chain information table (VTS_PGCIT), program chain information (PGCI), a program chain information table (PGCIT), and a cell playback time (C_PBTM). The VOBU address map can be obtained by sequentially tracing through such control information as the video title set information (VTSI), and a video title set video object unit address map (VTS_VOBU_ADMAP). The elapsed time of a VOBU within cell can be obtained by sequentially tracing through such control information as a navigation pack (NV_PCK), data search information (DSI), and a cell elapsed time (C_ELTM). The search information of VOBU can be obtained by sequentially tracing through such control information as the navigation pack (NV_PCK) and the data search information (DSI).

FIG. 3 is a schematic diagram for explaining one example of contents of a VOBU address map that is used for time search processing in this embodiment. The example of the VOBU address map shows ten VOBUs that form a title. Accordingly, this VOBU address map has a position a(0) storing the end address information of this VOBU address map, a position a(1) storing the address information of VOBU #1 which is the first VOBU of the title, a position a(2) storing the address information of VOBU #2 which is the second VOBU of the title, a position a(3) storing the address information of VOBU #3 which is the third VOBU of the title, a position a(4) storing the address information of VOBU #4 which is the fourth VOBU of the title, a position a(5) storing the address information of VOBU #5 which is the fifth VOBU of the title, a position a(6) storing the address information of VOBU #6 which is the sixth VOBU of the title, a position a(7) storing the address information of VOBU #7 which is the seventh VOBU of the title, a position a(8) storing the address information of VOBU #8 which is the eighth VOBU of the title, a position a(9) storing the address information of VOBU #9 which is the ninth VOBU of the title, and a position a(10) storing the address information of VOBU #10 which is the tenth VOBU of the title.

As an example, the position a(0) shows “43”. This figure “43” is obtained as a result of 4 bytes (number of bytes required for each piece of VOBU address information)×10 (number of VOBUs)+3 (value when there is no title)=43. Therefore, the figure “43” indicates the end address of VOBUs of the title, i.e., the end address of the position a(10) in which VOBU #10 is stored.

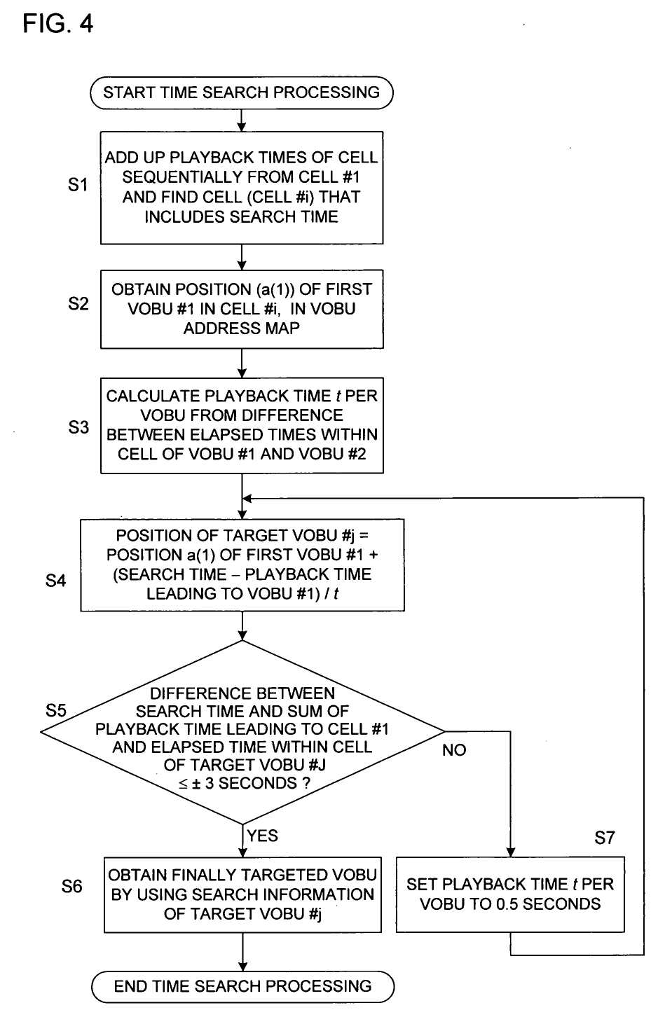

FIG. 4 is a flowchart for explaining the time search processing in this embodiment. The time search processing will be described with reference to this flow chart and FIGS. 1-3.

When a +VR formatted DVD is loaded into the optical disc recording/reproducing apparatus, the system controller 22 allows the DVD to rotate a slightly by rotating the spindle motor 5 through the servo controller 4 and the motor drive circuit 34. At the same time, the system controller 22 drives the optical pickup 2 by way of the servo controller 4, thereby reads out disc information, and performs spinup processing which involves moving the optical pickup 2 so as to set it at an initial position through the servo controller 4 and the sled 3.

Thereafter, when the user operates the remote controller 21 to instruct the system controller 22 to perform the time search, the system controller 22 executes the following processing for the time search.

Here, the optical disc which is loaded is a +VR formatted DVD, and the time search processing on this DVD will be described. The cell number search portion 221 sums up, starting sequentially from the first cell, the playback times of the plurality of cells that constitute a VOBS on the DVD and searches a cell number which includes the search time that is operationally set. Specifically, the cell number search portion 221 sums up, starting sequentially from CELL #1, the playback times of the cells and searches CELL #i (target cell) which includes the search time that is operationally set (step S1).

Next, based on a VOBU number of the first VOBU, the first VOBU position finding portion 222 obtains where the first VOBU #1 of the target cell CELL #i is positioned in the VOB address map that indicates a corresponding relationship between a VOBU number and an address thereof (step S2). The position is a(1) in this example.

Thereafter, the playback time calculation portion 223 calculates a playback time per VOBU from a difference between elapsed times within cell of the first VOBU #1 and the next VOBU #2. In other words, the playback time t per VOBU is calculated from the difference between the elapsed times of VOBU #1 and VOBU #2 within the target CELL #i (step S3).

Then, the target VOBU position calculation portion 224 calculates the position a(j) of a target VOBU #j which is considered to include the search time that is operationally set in the VOBU address map by executing the following formula. Position a(j) of target VOBU in VOBU address map=position a(i) of first VOBU #1 in VOBU address map+(search time that is operationally set−playback time leading to first VOBU #1)/playback time t per VOBU.

Assuming that, in FIG. 2, the search time that is operationally set is 126 seconds, the cell which includes this search time is CELL #i, the playback time leading to the first VOBU #1 in CELL #i is 120 seconds, and the playback time t per VOBU is 3 seconds, it is understood that the position of the target VOBU in the VOBU address map shown in FIG. 3 becomes a(3) which is a result of a(1)+(126−120)/3.

Thereafter, the time difference determination portion 225 determines whether or not a difference between the search time that is operationally set and the sum of the playback time leading to the target CELL #i and the elapsed time of the target VOBU #j (position a(j)) within cell is within a predetermined duration. In other words, it is determined whether or not the difference between the search time that is operationally set and the sum of the playback time leading to CELL #i and the elapsed time of VOBU #j within cell is within the above-mentioned playback time t per VOBU (e.g., ±3 seconds) (step S5).

Information of VOBUs that are played every 0.5 seconds within ±3 seconds from a given VOBU is recorded as search information of the VOBU. Accordingly, if it is determined that the above-mentioned difference is within the playback time t (e.g., ±3 seconds) per VOBU, the finally targeted VOBU for the time search is obtained by using the search information of the VOBU (step S6). On the other hand, if it is determined that the difference between the search time that is operationally set and the sum of the playback time leading to CELL #i and the elapsed time of VOBU #j within cell is not within the playback time t per VOBU (e.g., ±3 seconds), the playback time setting portion 227, in order to correct the playback time per VOBU which is calculated by the playback time calculation portion 223, set the above-mentioned playback time t per VOBU to a predetermined duration (e.g., 0.5 seconds) (step S7). Then, the flow returns to the process in step S4 and repeats a similar process. When the finally targeted VOBU for the time search is obtained, it means that the target for the time search is finalized, and the time search processing completes.

As described above, according to the present embodiment, it is possible to achieve a time search on a +VR formatted disc by using such control information as the playback time of cell, the VOBU address map, the elapsed time of VOBU within cell, and the search information of VOBU. Thus, even if a loaded optical disc is a DVD having information recorded thereon in +VR format, the time search is made possible, thereby enhancing the user friendliness.

According to another aspect of the present invention, it becomes possible to add a function to a DVD player or recorder so that a time search can be achieved on even a DVD having information thereon recorded in +VR format.

What is claimed is:

1. An optical apparatus that reproduces data recorded on an optical disc or that records/reproduces data on an optical disc, comprising a system controller that, when a loaded optical disc is a +VR (Video Recording) formatted DVD and a time search based on an inputted search time is performed on said DVD, performs:
summing up, sequentially from a first cell, playback times of a plurality of cells that constitute a VOBU (Video Object Unit) on the +VR formatted DVD, and searching a cell that includes the search time as a target cell;
obtaining a position of a first VOBU of the target cell in a VOBU address map that indicates a relationship between a VOBU number and an address thereof based on the VOBU number of the first VOBU;
calculating a playback time per VOBU from a difference between elapsed times within cell of the first VOBU and a next VOBU;
calculating a position of a target VOBU in the VOBU address map based on the position of the first VOBU in the VOBU address map, the search time, a playback time leading to the first VOBU, and the playback time per VOBU; and
obtaining a finally targeted VOBU in the time search by using search information of the target VOBU when a difference between the search time and a sum of a playback time leading to the target VOBU and an elapsed time of the target VOBU within cell is within a predetermined duration.

2. The optical apparatus according to claim 1,
wherein the system controller includes:
a cell number search portion that, when the loaded optical disc is a +VR (Video Recording) formatted DVD and the time search based on the inputted search time is performed on said DVD, sums up, sequentially from the first cell, the playback times of the plurality of cells that constitute a VOBU (Video Object Unit) on the +VR formatted DVD, and searches a cell that includes the search time as the target cell;
a first VOBU position finding portion that obtains the position of the first VOBU of the target cell in the VOBU address map that indicates a relationship between a VOBU number and an address thereof based on the VOBU number of the first VOBU;
a playback time calculation portion that calculates the playback time per VOBU from the difference between the elapsed times within cell of the first VOBU and the next VOBU;
a target VOBU position calculation portion that calculates the position of the target VOBU in the VOBU address map based on the position of the first VOBU in the VOBU address map, the search time, the playback time leading to the first VOBU, and the playback time per VOBU;
a time difference determination portion that determines whether the difference between the search time and the sum of the playback time leading to the target VOBU and the elapsed time of the target VOBU within cell is within the predetermined duration;
a target VOBU obtaining portion that obtains the finally targeted VOBU in the time search by using the search information of the target VOBU when the difference between the search time and the sum of the playback time leading to the target VOBU and the elapsed time of the target VOBU within cell is within the predetermined duration; and
a playback time setting portion that sets a predetermined duration to the playback time per VOBU so as to correct the playback time per VOBU which is calculated by the playback time calculation portion when the difference between the search time and the sum of the playback time leading to the target VOBU and the elapsed time of the target VOBU within cell is not within the predetermined duration.

3. The optical apparatus according to claim 2,
wherein the target VOBU obtaining portion calculates the position of the target VOBU in the VOBU address map by executing a formula of:
the position of the target VOBU in the VOBU address map=the position of the first VOBU in the VOBU address map+(the search time−the playback time leading to the first VOBU)/the playback time per VOBU.

4. An optical apparatus that reproduces data recorded on an optical disc or that records/reproduces data on an optical disc, comprising a system controller,
wherein the system controller includes:
a cell number search portion that, when a loaded optical disc is a +VR (Video Recording) formatted DVD and a time search based on an inputted search time is performed on said DVD, sums up, sequentially from a first cell, playback times of a plurality of cells that constitute a VOBU (Video Object Unit) on the +VR formatted DVD, and searches a cell that includes the search time as a target cell;
a first VOBU position finding portion that obtains a position of a first VOBU of the target cell in a VOBU address map that indicates a relationship between a VOBU number and an address thereof, based on the VOBU number of the first VOBU;
a playback time calculation portion that calculates a playback time per VOBU from a difference between elapsed times within cell of the first VOBU and a next VOBU;
a target VOBU position calculation portion that calculates a position of a target VOBU in the VOBU address map by executing a formula of: the position of the target VOBU in the VOBU address map=the position of the first VOBU in the VOBU address map+(the search time−a playback time leading to the first VOBU)/the playback time per VOBU;
a time difference determination portion that determines whether or not a difference between the search time and a sum of the playback time leading to the target VOBU and an elapsed time of the target VOBU within cell is within a predetermined duration;
a target VOBU obtaining portion that obtains a finally targeted VOBU in the time search by using search information of the target VOBU when the difference between the search time and the sum of the playback time leading to the target VOBU and the elapsed time of the target VOBU within cell is within the predetermined duration; and
a playback time setting portion that sets a predetermined duration to the playback time per VOBU so as to correct the playback time per VOBU which is calculated by the playback time calculation portion when the difference between the search time and the sum of the playback time leading to the target VOBU and the elapsed time of the target VOBU within cell is not within the predetermined duration.
